(19) United States
(12) Patent Application Publication
(10) Pub. No.: US 2021/0222724 A1
(43) Pub. Date: Jul. 22, 2021

(54) FASTENING NUT AND FASTENING ASSEMBLY

(71) Applicant: ILLINOIS TOOL WORKS INC., Glenview, IL (US)

(72) Inventors: Zheng LUO, Shanghai (CN); Zhaobao CAO, Shanghai (CN); Zhilin LI, Shanghai (CN)

(21) Appl. No.: 17/150,441

(22) Filed: Jan. 15, 2021

(30) Foreign Application Priority Data
Jan. 16, 2020 (CN) 202020098232.6
Dec. 15, 2020 (CN) 202023023884.2

(51) Int. Cl. F16B 39/02

(52) U.S. Cl. CPC F16B 39/025

(57) ABSTRACT

A fastening nut and a fastening assembly that includes the fastening nut. The fastening nut includes a collar and a receiving column, the receiving column includes an engageable receiving portion and a deformable receiving portion. The deformable receiving portion includes an upper barrel and a lower barrel connected to each other. The upper barrel has a right cone shape, the lower barrel has an inverted cone shape, and an outwardly-protruding bent portion is formed at a joint between the upper barrel and the lower barrel. The deformable receiving portion includes at least two holes provided at intervals in a circumferential direction of the receiving column.

### TECHNICAL FIELD

The present disclosure relates to a fastening assembly, and in particular to a fastening nut and a fastening assembly for blind riveting connection.

### BACKGROUND

Rivet nuts are often used for connections between parts or plates and mounting panels when an operation space is limited. Generally speaking, an operator causes a rivet nut to pass through a mounting hole of the mounting panel and then abut against one side of the mounting panel, and then causes the rivet nut to squeeze a connected plate, i.e. the mounting panel by means of a blind riveter or other mounting tools to generate squeezing deformation, thereby fastening and connecting the rivet nut to the mounting panel. Then other parts or plates are connected to the mounting panel by means of the rivet nuts.

### SUMMARY OF THE DISCLOSURE

The inventor has observed that in the prior art, when the strength of the material of a mounted panel is not high enough, a squeezing force of a rivet nut on the mounting panel may cause tearing near a mounting hole of the mounting panel and in extreme circumstance causes the mounting panel to be deformed to a certain degree, and then the rivet nut may be disengaged from the mounting panel, which affects the riveting reliability.

Therefore, in a first aspect, the present disclosure provides a fastening nut, comprising a collar and a receiving column, wherein the receiving column is connected to one side of the collar, and the receiving column comprises: an engageable receiving portion, inwardly-protruding engaging teeth being provided on at least part of an inner wall of the engageable receiving portion; and a deformable receiving portion, the deformable receiving portion connecting the engageable receiving portion to the collar, the deformable receiving portion comprising an upper barrel and a lower barrel connected to each other, wherein the upper barrel is connected to the collar, the lower barrel is connected to the engageable receiving portion, the upper barrel has a right cone shape, the lower barrel has an inverted cone shape, and an outwardly-protruding bent portion is formed at a joint between the upper barrel and the lower barrel; and the deformable receiving portion comprises at least two holes provided at intervals in a circumferential direction of the receiving column, each of the at least two holes extending from the upper barrel to the lower barrel.

According to the first aspect described as above, the deformable receiving portion comprises at least two legs formed between adjacent holes, each of the at least two legs comprising an upper leg and a lower leg, wherein the upper leg is formed by the upper barrel, the lower leg is formed by the lower barrel, and the upper leg and the lower leg are connected at the bent portion; and wherein the upper leg extends from the bent portion to the collar in an inwardly inclined manner, and the lower leg extends from the bent portion to the engageable receiving portion in an inwardly inclined manner.

According to the first aspect described as above, an included angle formed between the upper leg and the lower leg is an obtuse angle.

According to the first aspect described as above, the engageable receiving portion comprises an engageable receiving cylinder and a guide portion, the guide portion being connected between the deformable receiving portion and the engageable receiving cylinder, such that the guide portion smoothly connects the deformable receiving portion and the engageable receiving cylinder.

According to the first aspect described as above, a minimum inner diameter of the deformable receiving portion is greater than a maximum inner diameter of the engageable receiving cylinder.

According to the first aspect described as above, the guide portion forms a spherical surface.

According to the first aspect described as above, the at least two legs are symmetrically arranged with respect to a center of the receiving column.

According to the first aspect described as above, the fastening nut further comprises an rotation preventing arm, wherein the rotation preventing arm is formed by extending downwardly from an periphery of the collar.

In a second aspect, the present disclosure provides a fastening assembly, comprising: a fastening bolt having a thread; and a fastening nut according to the first aspect above, wherein the thread of the fastening bolt is engageable with the inwardly-protruding engaging teeth of the engageable receiving portion of the fastening nut, and the fastening nut is configured in such a way that when the fastening bolt is inserted into the receiving column of the fastening nut and engages with the engageable receiving portion of the receiving column, the deformable receiving portion of the fastening nut is bent and deformed such that the engageable receiving portion moves toward the collar.

According to the second aspect described as above, the fastening assembly is used for being mounted in a mounting hole of a mounting panel, wherein the size of the mounting hole of the mounting panel is greater than the minimum size of the deformable receiving portion and less than the maximum size of the deformable receiving portion.

According to the second aspect described as above, the fastening nut comprises an rotation preventing arm, the rotation preventing arm being formed by extending downwardly from an periphery of the collar, and the rotation preventing arm being configured to be inserted into an rotation preventing hole in the mounting panel.

By means of a shape design of the deformable receiving portion provided on the fastening nut, the present disclosure reduces bending force required by the deformation of the deformable receiving portion, thereby reducing a squeezing force on a connected plate when the deformable receiving portion is bent and deformed. On one hand, an operator can complete fastening operation on the fastening nut only by manually tightening the fastening bolt, and on the other hand, the connected plate will not be damaged even if the strength of the connected plate is not high. In addition, the fastening nut according to the present disclosure can meet work environment and operation requirements of the rivet nut.

### BRIEF DESCRIPTION OF THE DRAWINGS

FIGS. 1A and 1B are structural perspective diagrams of a fastening nut 100 according to the present disclosure observed from two perspectives;

FIG. 1C is a bottom view of the fastening nut 100 shown in FIG. 1A;

FIG. 2A is a cross-sectional view of the fastening nut 100 shown in FIG. 1C along line A-A;

FIG. 2B is a cross-sectional view of the fastening nut 100 shown in FIG. 1C along line B-B;

FIG. 3A is a structural perspective diagram of the deformed fastening nut 100;

FIG. 3B is a bottom view of the deformed fastening nut 100 shown in FIG. 3A;

FIG. 4 is a cross-sectional view of the deformed fastening nut 100 shown in FIG. 3B along line C-C;

FIGS. 5A-5E are structural diagrams of a connection process for connecting two plates via a fastening bolt and the fastening nut.

### DETAILED DESCRIPTION OF EMBODIMENTS

Various specific embodiments of the present disclosure will be described below with reference to the accompanying drawings, which form part of this description. It should be understood that although the terms, such as “front”, “rear”, “upper”, “lower”, “left”, “right”, “top”, “bottom”, “inner” and “outer”, indicating orientations are used in the present disclosure to describe structural parts and elements in various examples of the present disclosure, these terms are used herein only for ease of illustration and are determined based on the exemplary orientations shown in the accompanying drawings. Since the embodiments disclosed in the present disclosure can be arranged in different directions, these terms indicating directions are only illustrative and should not be considered as limitations. Where possible, the same or similar reference signs used in the present disclosure refer to the same components.

For ease of description, in the present disclosure, a height direction of the fastening nut is taken as an axial direction of the fastening nut, a direction perpendicular to the axial direction is taken as a radial direction, and a direction around the axial direction of the fastening nut is taken as a circumferential direction of the fastening nut.

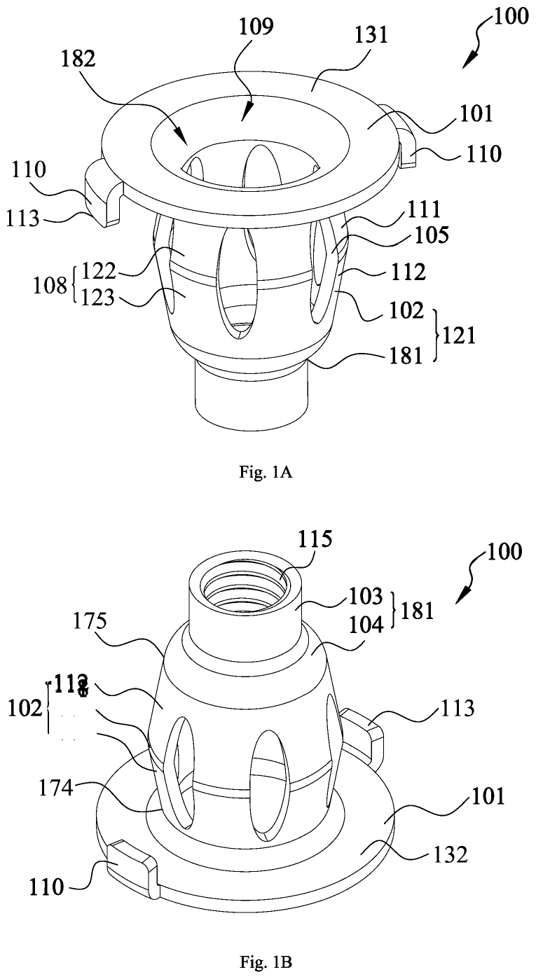

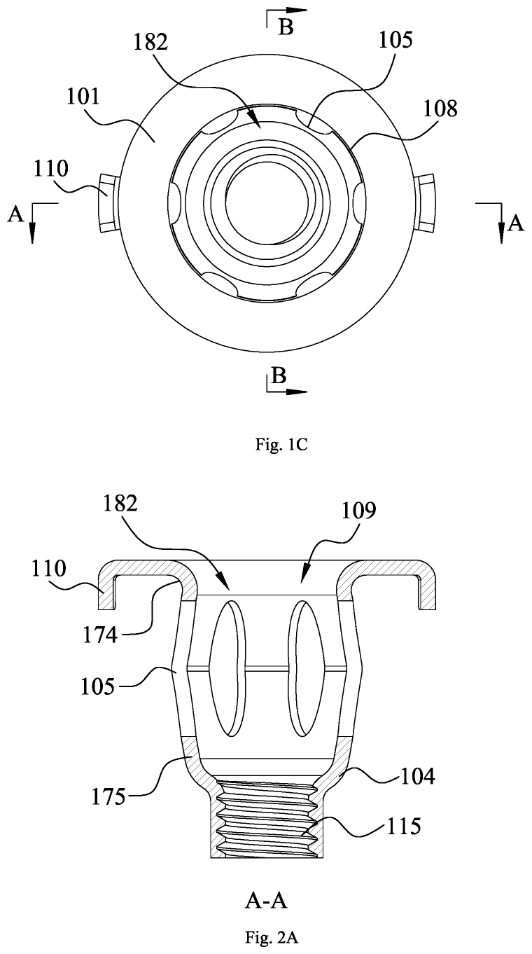

FIGS. 1A-1C are structural schematic diagrams of the fastening nut 100 according to the present disclosure for showing a general structure of the fastening nut 100, wherein FIGS. 1A and 1B show structural perspective diagrams of the fastening nut 100 observed from top and bottom perspectives, and FIG. 1C shows a bottom view of the fastening nut 100 in the orientation shown in FIG. 1A for illustrating the general structure of the fastening nut 100.

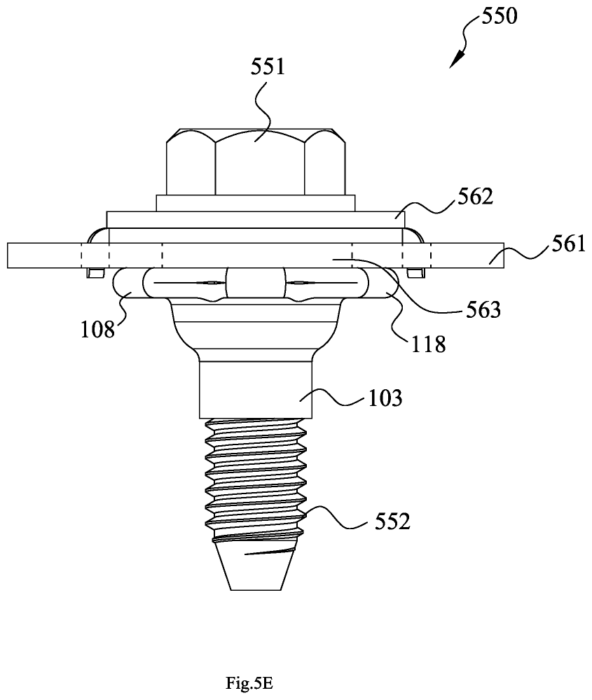

As shown in FIGS. 1A and 1B, the fastening nut 100 is substantially axisymmetric in shape and comprises a collar 101 and a receiving column 121, wherein the receiving column 121 is connected below the collar 101. The fastening nut 100 is hollow in shape and has a receiving channel 182 penetrating therethrough, and the receiving channel 182 extends from the collar 101 to the receiving column 121 in the axial direction of the fastening nut 100 and is used for receiving a fastening bolt 551 (see FIG. 5C).

In the embodiment shown in FIGS. 1A and 1B, the collar 101 is substantially annular in a direction perpendicular to the axial direction of the fastening nut 100, and an outer contour of the collar 101 is circular, and may be otherwise of another shape such as square, rectangle, or ellipse. The collar 101 is provided with an opening 109, and the opening 109 forms an inlet of the receiving channel 182. The collar 101 comprises a substantially flat top face 131 and bottom face 132, wherein the top face 131 is used for making contact with a connecting plate 562, and the bottom face 132 is used for making contact with a connected plate 561 (i.e., a mounting panel) (see FIGS. 5C-5E).

In this way, the fastening nut 100 may be inserted into a mounting hole 563 in the connected plate 561 first, and the connecting plate 562 may then be securely connected to the connected plate 561 by connecting the fastening nut 100 to the fastening bolt 551 (see FIG. 5E).

The fastening nut 100 further comprises an rotation preventing arm 110 formed by extending downward from an periphery of the collar 101, a downwardly-extending free end 113 of the rotation preventing arm 110 may cooperate with an rotation preventing hole 564 in the connected plate 561 (see FIG. 5A), and the free end 113 extends into the rotation preventing hole 564 to abut against a hole wall of the rotation preventing hole 564, so as to prevent the fastening nut 100 and the connected plate 561 from rotating relative to each other in the mounting process. In the example shown in the figures, the rotation preventing arm 110 comprises a pair of oppositely disposed rotation preventing arms. Of course, more rotation preventing arms may be provided depending on a requirement for an rotation preventing force.

The receiving column 121 is of a hollow barrel structure, and a part of the receiving channel 182 is formed in the hollow interior of the receiving column 121. In this embodiment, the receiving column 121 sequentially comprises a deformable receiving portion 102 and an engageable receiving portion 181 from top to bottom, the deformable receiving portion 102 connecting the engageable receiving portion 181 to the collar 101. The engageable receiving portion 181 sequentially comprises, from top to bottom, a guide portion 104 and an engageable receiving cylinder 103 connected to each other. The deformable receiving portion 102 is provided at the top of the receiving column 121, the engageable receiving cylinder 103 is provided at the bottom of the receiving column 121, and the guide portion 104 is connected between the deformable receiving portion 102 and the engageable receiving cylinder 103. When the receiving channel 182 receives the fastening bolt 551, the engageable receiving cylinder 103 of the receiving column 121 engages with the fastening bolt 551, and the deformable receiving portion 102 of the receiving column 121 can be bent and deformed.

The deformable receiving portion 102 sequentially comprises an upper barrel 111, a bent portion 118, and a lower barrel 112 connected to one another from top to bottom. The upper barrel 111 and the lower barrel 112 are substantially in the shapes of coaxially-arranged conical barrels, and the outwardly-protruding bent portion 118 is formed at a joint between the upper barrel 111 and the lower barrel 112. Specifically, the upper barrel 111 has a top edge 174, the top edge 174 being connected to a bottom face 132 of the collar 101. The lower barrel 112 has a bottom edge 175, the bottom edge 175 being connected to the guide portion 104. In addition, in a top-to-bottom direction (i.e., a direction from the collar 101 to the engageable receiving cylinder 103), the upper barrel 111 has a right cone shape extending in an outwardly inclined manner, the lower barrel 112 has an inverted cone shape extending in an inwardly contracted manner, and the outwardly-protruding bent portion 118 is formed at the joint between the upper barrel 111 of the right cone shape and the lower barrel 112 of the inverted cone shape.

The deformable receiving portion 102 further comprises a plurality of holes 105 penetrating a side wall of the deformable receiving portion 102, and the holes 105 are disposed at intervals in a circumferential direction of the deformable receiving portion 102. The deformable receiving portion 102 further comprises at least two legs 108 formed between adjacent holes 105, and every two legs 108 are separated by a hole 105. In this embodiment, the hole 105 is an elongated hole of an oval shape, and the hole 105 extends in a length direction thereof from the upper barrel 111 to the lower barrel 112 through the bent portion 118. Each leg 108 comprises an upper leg 122 formed by the upper barrel 111 and a lower leg 123 formed by the lower barrel 112, the upper leg 122 and the lower leg 123 being connected at the bent portion 118. Due to the shapes of the upper barrel 111 and the lower barrel 112, the upper leg 122 extends from the bent portion 118 to the collar 101 in an inwardly inclined manner, and the lower leg 123 extends from the bent portion 118 to the engageable receiving portion 181 in an inwardly inclined manner. That is, in the top-to-bottom direction (i.e., in the direction from the collar 101 to the engageable receiving cylinder 103), the upper leg 122 extends in an outwardly inclined manner and the lower leg 123 extends in an inwardly contracted manner. The specific number of the holes 105 and the legs 108 may be set according to actual requirements, the greater the number of the holes 105 and the legs 108 is, the more bending and deformation of the deformable receiving portion 102 can be achieved, but the strength of the fastening nut 100 may be influenced. In the embodiment shown in FIGS. 1A-1C, the deformable receiving portion 102 comprises six holes 105, and six legs 108 are thus formed.

The engageable receiving cylinder 103 is of a cylinder shape, inwardly-protruding engaging teeth 115 are provided on an inner wall of the engageable receiving cylinder 103, and the engaging teeth 115 are used for engaging with the fastening bolt 551 (see FIG. 5C).

The guide portion 104 is in the shape of an outwardly-protruding sphere and is smoothly connected between the bottom edge 175 of the lower barrel 112 and the engageable receiving cylinder 103.

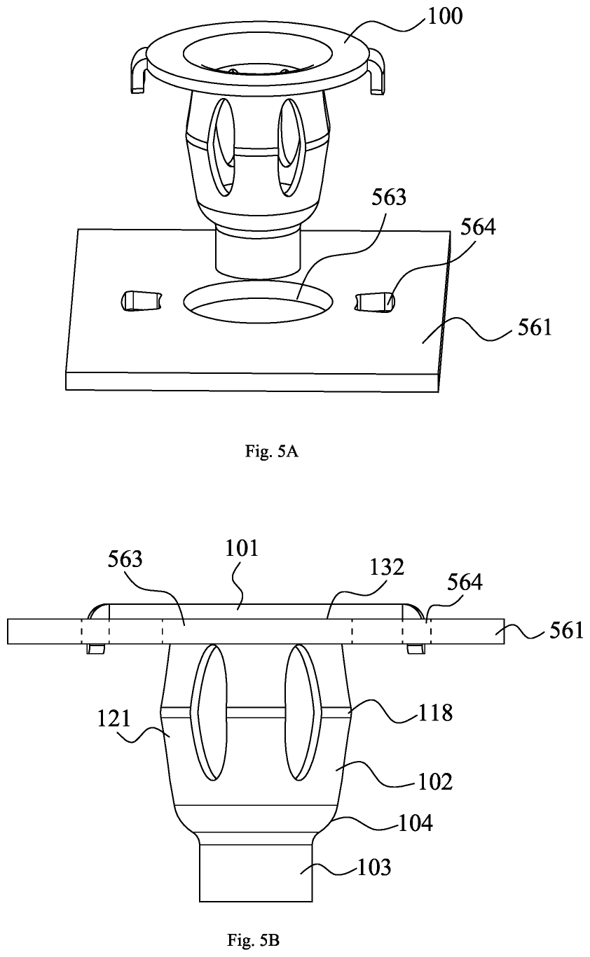

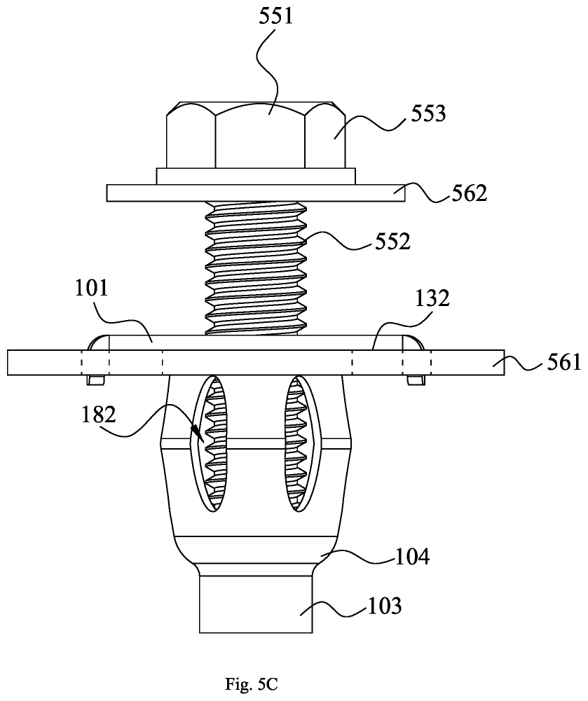

When an operator tightens the fastening bolt 551 to insert the fastening bolt 551 downward into the receiving channel 182, the fastening bolt 551 may engage with the engageable receiving cylinder 103, and the rotation of the fastening bolt 551 causes relative movement between the fastening bolt 551 and the engageable receiving cylinder 103. Under the condition that the fastening bolt 551 cannot continue to move downwardly at this moment, the engageable receiving cylinder 103 will be subject to an upward counter-acting force. Under the action of the counter-acting force, the engageable receiving cylinder 103 may move upwardly toward the collar 101 such that the deformable receiving portion 102 can be deformed and bent outwardly. A specific process in which the deformable receiving portion 102 is deformed will be described in more detail later in conjunction with FIGS. 3A and 3B.

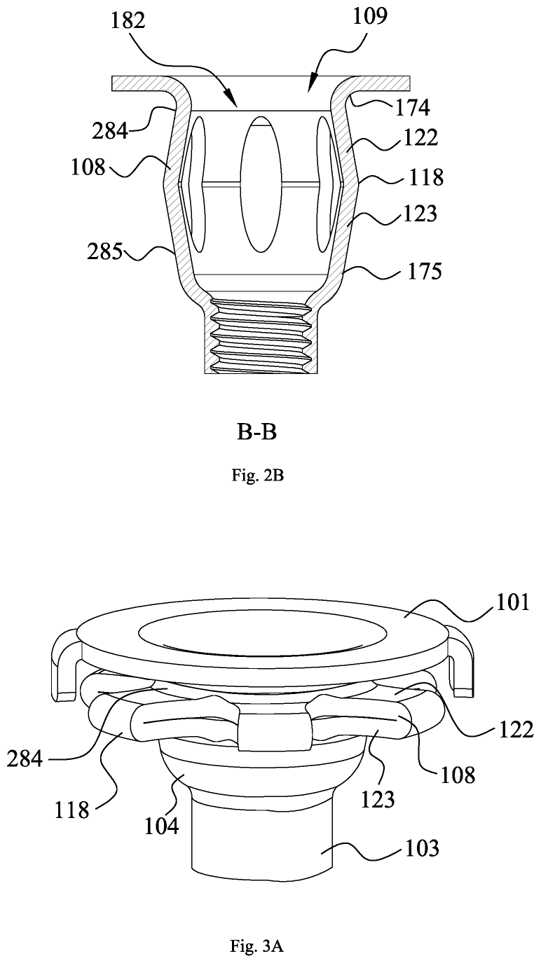

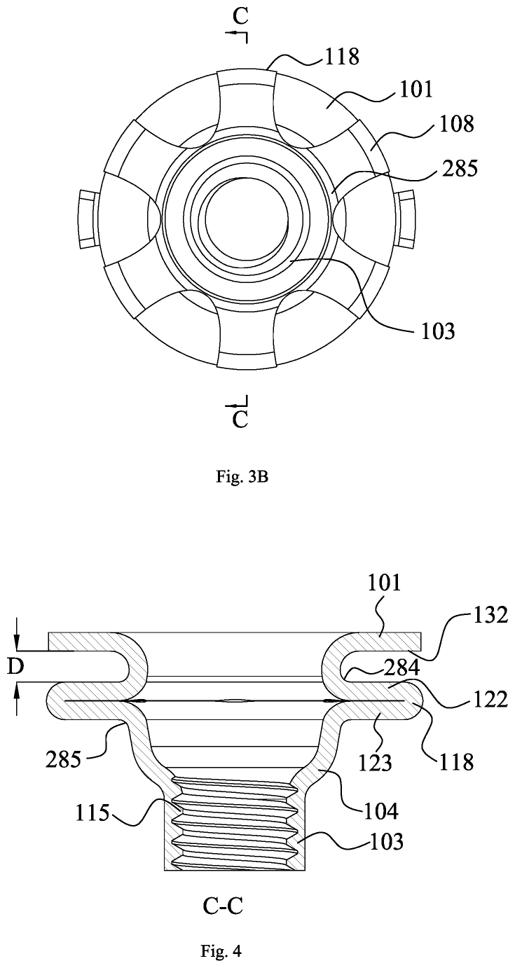

FIGS. 2A and 2B are cross-sectional views of the fastening nut 100 in FIG. 1C along lines A-A and B-B respectively to illustrate a more specific structure of the fastening nut 100, wherein FIG. 2A is taken at the hole 105 of the deformable receiving portion 102, and FIG. 2B is taken at the leg 108 of the deformable receiving portion 102.

As shown in FIGS. 2A and 2B, the interior of the fastening nut 100 is hollow, and the receiving channel 182 penetrates the fastening nut 100 longitudinally, wherein the fastening nut 100 has a uniform wall thickness, such that the outer contour of the fastening nut 100 is substantially of the same shape as the inner contour thereof. In the receiving column 121 of the fastening nut 100, the dimensions (comprising the outer and inner diameters) of the deformable receiving portion 102 increase from the top edge 174 to the bent portion 118 and decrease from the bent portion 118 to the bottom edge 175; the dimensions (comprising the outer diameter and the maximum inner diameter not including the engaging teeth) of the engageable receiving cylinder 103 remain unchanged from top to bottom and are less than the corresponding dimensions of the top edge 174 and the bottom edge 175 of the deformable receiving portion 102; and the dimensions (comprising the inner and outer diameters) of the guide portion 104 decrease from top to bottom and the guide portion 104 is smoothly connected between the bottom edge 175 and the top of the engageable receiving cylinder 103.

Specifically, the outer diameter of the deformable receiving portion 102 is configured to match the diameter of the mounting hole 563 of the connected plate 561, for example, the outer diameter at the bent portion 118 is slightly greater than the hole diameter of the mounting hole 563, while the outer diameters at the top edge 174 and the bottom edge 175 are less than or match the diameter of the mounting hole 563. After the deformable receiving portion 102 is bent and deformed, the legs 108 expand outwardly, and the outer diameter, at the bent portion 118, of the deformable receiving portion 102 becomes greater, resulting in a greater retention force of the fastening nut 100. In addition, the outer diameter of the engageable receiving cylinder 103 is less than the outer diameter of the mounting hole 563. In this way, when the operator presses the fastening nut 100 with a certain insertion force, the receiving column 121 of the fastening nut 100 may pass through the mounting hole 563, while the bottom face 132 of the collar of the fastening nut 100 abuts against the connected plate 561 (see FIG. 5B).

The inner diameter of the engageable receiving cylinder 103 is configured to match the outer diameter of the fastening bolt 551, such that the engageable receiving cylinder 103 can securely engage with the fastening bolt 551. The inner diameter of the deformable receiving portion 102 is configured to be greater than the inner diameter of the engageable receiving cylinder 103, so as to facilitate insertion of the fastening bolt 551 into the receiving channel 182 from above the fastening nut 100. The guide portion 104 is smoothly connected between the bottom edge 175 and the engageable receiving cylinder 103 in an inwardly contracted manner from top to bottom.

In this way, when the fastening bolt 551 is inserted into the receiving channel 182 of the fastening nut 100 from the opening 109 on the collar 101, the guide portion 104 may have a guiding function to guide an end portion of the fastening bolt 551 into the engageable receiving cylinder 103 with the smaller inner diameter from the deformable receiving portion 102 with the larger inner diameter. On the other hand, when the engageable receiving cylinder 103 is subject to an upward counter-acting force, the guide portion 104 may have a better support function to transfer the counter-acting force to the deformable receiving portion 102 to make the deformable receiving portion 102 bent and deformed. It should be noted that in some embodiments, the engageable receiving portion may also comprise the engageable receiving cylinder 103 only without the guide portion 104. In this case, the bottom edge 175 of the lower barrel 112 is directly connected to the engageable receiving cylinder 103.

As shown in FIG. 2A, the length of the hole 105 of the deformable receiving portion 102 may be configured as long as possible to increase the length of the leg 108 as much as possible, for example, the top of the hole 105 is close to but does not reach the top edge 174 and the bottom of the hole 105 is close to but does not reach the bottom edge 175, such that the top end 284 of the leg 108 and the bottom end 285 of the leg 108 formed between the holes 105 at intervals may also be close to but do not reach the top edge 174 and the bottom edge 175. As an example, when the deformable receiving portion 102 is bent and deformed, the leg 108 is deformed to expand outwardly from the top end 284 and the bottom end 285 thereof. The longer leg 108 is, the more the leg expands outward, and the better the fastening nut 100 may be prevented from being disengaged from the mounting hole (see FIG. 5E).

As shown in FIGS. 2A and 2B, an included angle formed between the upper barrel 111 and the lower barrel 112 of the deformable receiving portion 102 is an obtuse angle, and an included angle formed between the upper leg 122 and the lower leg 123 is also an obtuse angle. In this way, the outer diameter at the bent portion 118 is greater than the outer diameter of the top edge 174 of the upper barrel 111 and the outer diameter of the bottom edge 175 of the lower barrel 112, such that the bent portion 118 can protrude outwardly. When the deformable receiving portion 102 is bent and deformed, inclination directions of the upper leg 122 and the lower leg 123 and the outwardly-protruding bent portion 118 may make each leg 108 bend outwardly at the bent portion 118. Such a structure is easy to bend, and the bending direction can be controlled.

Those skilled in the art can set the included angle formed between the upper barrel 111 and the lower barrel 112 according to a specific size of the mounting hole and other factors. In this embodiment, the included angle is about 160°. By means of such an arrangement, the bending and deformation direction of the leg 108 can be guided, and the outer diameter at the outwardly-protruding bent portion 118 may also be slightly greater than that of the mounting hole 563 in the connected plate 561. After the operator tilts or forcibly presses the fastening nut 100 to cause the receiving column 121 of the fastening nut 100 to pass through the mounting hole 563, the bent portion 118 may further prevent the fastening nut 100 from being disengaged from the mounting hole 563 (see FIGS. 5A and 5B) in reverse direction.

FIGS. 3A and 3B show a deformed fastening nut 100, wherein FIG. 3A is a perspective view and FIG. 3B is a bottom view. In this embodiment, the deformed fastening nut 100 refers to a fastening nut 100 with a deformable receiving portion 102 having been bent and deformed. As shown in FIGS. 3A and 3B, the deformable receiving portion 102 substantially forms a petal shape after being bent and deformed, with each leg 108 forming one of petals after being bent.

Specifically, each upper leg 122 is bent outwardly from the root of the top end 284 thereof to form a substantially horizontal upper leg 122. Each lower leg 123 is bent outwardly from the root of the bottom end 285 thereof to form a substantially horizontal lower leg 123. As described above, each leg 108 is bent outwardly at the bent portion 118, such that the upper leg 122 abuts onto the lower leg 123. The legs 108 are circumferentially spaced from one another such that they can be bent and form a circle. In this embodiment, the deformable receiving portion 102 comprises six legs 108, and the bent legs 108 form a circle with an angular spacing of 60° therebetween.

In this embodiment, the legs 108 are spaced by holes 105, thereby reducing the bending force required for bending the legs 108. Moreover, the upper legs 122 and the lower legs 123 each have a certain inclination direction, which can guide the bent portion 118 to be bent outwardly, thereby facilitating the bending and deformation of the deformable receiving portion 102. Therefore, by setting the specific shape of the deformable receiving portion 102, the operator can achieve the deformation of the deformable receiving portion 102 by manually tightening the fastening bolt even only with a general tool such as a wrench without the need for additional assembly tools. Since the bending force required for bending the deformable receiving portion 102 is reduced, a squeezing force that squeezes the connected plate 562 when the deformable receiving portion 102 is deformed is also reduced. Furthermore, according to the fastening nut 100 of this embodiment, since the rotation preventing arm 110 is engaged with the rotation preventing hole 564 in the connected plate 561, the fastening nut 100 is prevented from rotating relative to the connected plate 561 when the fastening bolt is manually tightened.

It should be noted that in some embodiments, according to the difference of the thickness of the connected plate 561, the outwardly-bent portion of the upper leg 122 may also not be at the root of the top end 284 thereof, but at a position where the periphery of the mounting hole 563 of the connected plate 561 makes contact with the upper leg 122. As a result, the fastening nut 100 may be adapted to the connected plates 561 with various thicknesses.

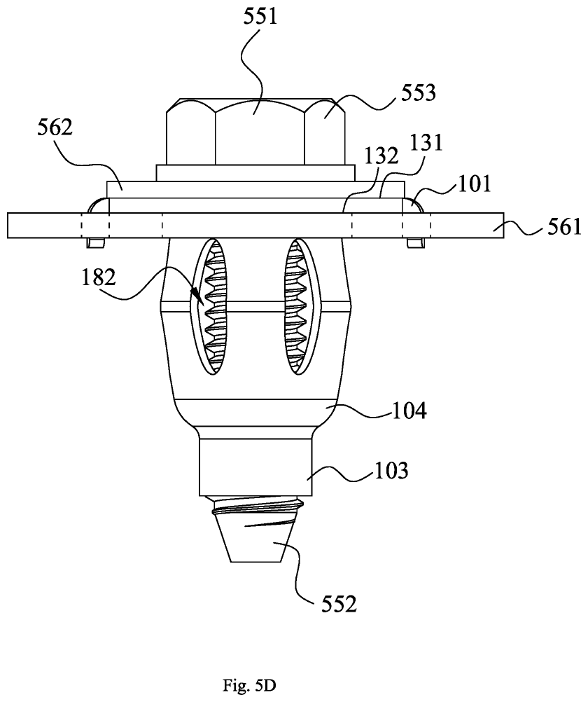

FIG. 4 shows a cross-sectional view of the deformed fastening nut 100 in FIG. 3B along line C-C for illustrating a more specific structure of the deformed fastening nut 100.

As shown in FIG. 4, after the deformable receiving portion 102 is bent and deformed, the bottom face 132 of the collar 101 is spaced from the upper leg 122 by a distance D, and the distance D is used for accommodating the connected plate 561, such that the bottom face 132 of the collar 101 and the upper leg 122 can clamp the connected plate 561 from two sides of the connected plate 561, thereby securely connecting the fastening nut 100 to the connected plate 561 (see FIG. 5E).

When the fastening bolt 551 is screwed into the receiving channel 182, under the condition that the fastening bolt 551 cannot continue to move downwardly (for example, in a state as shown in FIG. 5D), the engageable receiving cylinder 103 is subject to the upward force, and the engageable receiving portion 181 moves as a whole toward the collar 101, resulting in a reduction of a distance between the collar 101 and the engageable receiving portion 181. In this case, the bent portion 118 of the deformable receiving portion 102 is bent outwardly such that the included angle formed between the upper leg 122 and the lower leg 123 is changed from an obtuse angle to approximately 0 degree angle, and the height (i.e., the distance between the top edge 174 and the bottom edge 175) of the deformable receiving portion 102 is reduced, thereby allowing the distance between the collar 101 and the engageable receiving portion 181 to be reduced accordingly.

FIGS. 5A-5D show the process for connecting the connected plate 561 and the connecting plate 562 together by using the fastening assembly 550, wherein the fastening assembly 550 comprises the fastening bolt 551 and the fastening nut 100. FIG. 5A shows a state in which the fastening nut 100 is aligned with the mounting hole 563 and the rotation preventing holes 564 in the connected plate 561; FIG. 5B shows a state in which the fastening nut 100 is inserted into the mounting hole 563 and the rotation preventing holes 564 in the connected plate 561; FIG. 5C shows a state in which the fastening bolt 551 is pressed against the connecting plate 562 and the fastening bolt 551 is inserted into the receiving channel 182 of the fastening nut 100; FIG. 5D shows a state in which the fastening bolt 551 is fully inserted into the receiving channel 182 of the fastening nut 100; and FIG. 5E shows a state in which the fastening nut 100 is deformed such that the connected plate 561 and the connecting plate 562 are fastened between the fastening bolt 551 and the fastening nut 100.

As shown in FIG. 5A, the mounting hole 563 and the two rotation preventing holes 564 are provided in the connected plate 561, and the two rotation preventing holes 564 are respectively located on two opposite sides of the mounting hole 563. The operator aligns the receiving column 121 of the fastening nut 100 with the mounting hole 563 from an upper side of the connected plate 561 and aligns each of the two rotation preventing arms 110 of the fastening nut 100 with one of the rotation preventing holes 564. The outer diameters of the engageable receiving cylinder 103 and the guide portion 104 of the fastening nut 100 are both less than the diameter of the mounting hole 563, while the outer diameter of the bent portion 118 is slightly greater than the diameter of the mounting hole 563. When the operator tilts or presses the fastening nut 100 with a certain insertion force, the engageable receiving cylinder 103 and the guide portion 104 of the receiving column 121 of the fastening nut 100 pass through the mounting hole 563 first, then the bent portion 118 may also pass through the mounting hole 563, and the free end 113 of the rotation preventing arm 110 extends into the rotation preventing hole 564 until the state as shown in FIG. 5B is reached.

As shown in FIG. 5B, the receiving column 121 of the fastening nut 100 is connected to a lower side of the connected plate 561, while the bottom face 132 of the collar 101 abuts against the upper side of the connected plate 561. in this case, the fastening nut 100 has not been securely connected to the connected plate 561, but the fastening nut 100 will not be disengaged from the mounting hole 563 from bottom to top in the absence of an external force due to the fact that the outer diameter of the bent portion 118 is slightly greater than the diameter of the mounting hole 563.

As shown in FIG. 5C, the operator again aligns the fastening bolt 551 and the connecting plate 562 with the fastening nut 100 from above the connected plate 561, wherein a threaded rod 552 of the fastening bolt 551 is used for being inserted into the receiving channel 182 of the fastening nut 100. Due to the relative large size of the opening 109 on the collar 101, i.e. the inlet of the receiving channel 182, the operator may easily align the fastening bolt 551 with the opening 109 and insert the fastening bolt into the receiving channel 182. The guide portion 104 can smoothly guide the fastening bolt 551 to align with the engaging teeth 115 of the engageable receiving cylinder 103 when the fastening bolt 551 is inserted into a position where it comes into contact with an inner wall of the guide portion 104. In the state shown in FIG. 5C, the fastening bolt 551 and the connecting plate 562 are still spaced from the fastening nut 100 and the connected plate 561 by a certain distance.

The operator may tighten the fastening bolt 551 from above the connected plate 561 by using a conventional hexagon wrench or another tool for engaging a screw cap 553 of the fastening bolt 551, the fastening bolt 551 and the connecting plate 562 move downwardly together relative to the fastening nut 100 and the connected plate 561 by engaging the threaded rod 552 of the fastening bolt 551 with the engaging teeth 115 of the engageable receiving cylinder 103, until the state as shown in FIG. 5D is reached. In this case, since each of the two rotation preventing arms 110 is inserted into one of the rotation preventing holes 564, the fastening nut 100 will not rotate relative to the connected plate 561 when the fastening bolt 551 is tightened by the operator.

As shown in FIG. 5D, the fastening bolt 551 and the connecting plate 562 presses against the top face 131 of the collar 101, such that the fastening bolt 551 and the connecting plate 562 cannot continue to move downwardly relative to the fastening nut 101. In this case, the receiving column 121 of the fastening nut 100 is still connected to the lower side of the connected plate 561, and the bottom face 132 of the collar 101 abuts against the upper side of the connected plate 561. The threaded rod 552 of the fastening bolt 551 is fully inserted into the receiving channel 182, and the screw cap 553 of the fastening bolt 551 is pressed against the upper side of the connecting plate 562. In this way, the connecting plate 562 can be connected to the connected plate 561 by means of the secure connection between the fastening bolt 551 and the fastening nut 100. It should be noted that although the fastening bolt 551 is securely connected to the engageable receiving cylinder 103 of the fastening nut 100, the fastening nut 100 is still not securely connected to the connected plate 561 at this moment.

When the operator continues to tighten the fastening bolt 551 from above the connected plate 561, the fastening bolt 551 cannot continue to move downwardly relative to the fastening nut 100 and the connected plate 561. The engageable receiving cylinder 103 is subject to the upward counter-acting force, such that the engageable receiving cylinder 103 has a tendency to move upwardly relative to the fastening bolt 551. When the force applied by the operator to tighten the fastening bolt 551 meets a requirement of a bending force, the deformable receiving portion 102 is bent and deformed to reach the state as shown in FIG. 5E.

As shown in FIG. 5E, the deformable receiving portion 102 of the fastening nut 100 is bent and deformed, and each leg 108 of the deformable receiving portion 102 is bent outwardly from the bent portion 118. The upper leg 122 is bent approximately to a horizontal orientation, the upper leg 122 abuts the connected plate 561, and the lower leg 123 is also bent into a horizontal orientation and abuts the upper leg 122. The engageable receiving cylinder 103 moves upwardly relative to the fastening bolt 551. The outward expansion size of the bent leg 108 is greater than the diameter of the mounting hole 563, such that the collar 101 and the bent leg 108 clamp the connected plate 561 from the two sides of the connected plate 561, thereby preventing the fastening nut 100 from moving up and down relative to the connected plate 561, i.e., the process for fastening the fastening nut 100 to the connected plate 561 is completed.

In this case, the connecting plate 562 is fixed between the fastening bolt 551 and the collar 101 of the fastening nut 100, and when the connected plate 561 is securely connected relative to the fastening nut 100, the connecting plate 562 can also be securely connected to the connected plate 561, i.e., the process for fastening the connecting plate 562 to the connected plate 561 by means of the fastening assembly 550 is completed.

In this way, the operator can connect the connecting plate to the connected plate by manually screwing the fastening bolt 551 into the fastening nut 100 only with a general tool such as a wrench without the need for additional apparatuses such as a blind riveter, which is convenient to mount and easy to achieve.

In this embodiment, the mounting process is described by taking the connecting plate 562 as an example, but in other embodiments, the connecting plate 562 may be another part. In some embodiments, the fastening assembly 550 may also comprise another fastener instead of the fastening bolt 551, so long as the fastener has a threaded section cooperating with the engageable receiving cylinder 103. In other embodiments, the operator may also use the fastening nut 100 to connect some parts having threaded sections that cooperate with the engageable receiving cylinder 103 to the connected plate 561 (i.e., the mounting panel).

Before the fastening nut 100 is inserted into the connected plate 561, the operator may insert the fastening nut 100 into the mounting hole 563 of the connected plate 561 with only a small insertion force. After the fastening connection between the fastening nut 100 and the connected plate 561 is completed, the bent and deformed legs 108 abut against a periphery of the mounting hole 563 of the connected plate 561 in the circumferential direction, such that the fastening nut 100 has a large pulling-out force and a retention force.

As described above, by means of a shape design of the deformable receiving portion, the present disclosure reduces the requirement for a bending force required by the deformation of the deformable receiving portion, thereby reducing a squeezing force on a connected plate when the deformable receiving portion is bent and deformed. On one hand, an operator can complete fastening operation on the fastening nut only by manually tightening the fastening bolt, and on the other hand, the connected plate will not be damaged even if the strength of the connected plate is not high.

In addition, according to the present disclosure, the rotation preventing arm is provided on the fastening nut, and the rotation preventing hole is correspondingly provided in the connected plate, such that when the rotation preventing arm extends into the rotation preventing hole, a hole wall of the rotation preventing hole can prevent the fastening nut from rotating. Therefore, when the operator manually tightens the fastening bolt, no other tools need to be provided to prevent the fastening nut from rotating relative to the connected plate.

Moreover, in the present disclosure, all the mounting actions of the operator can be completed on one side of the connected plate, which is particularly suitable for the situation that an operation space on the other side of the connected plate is limited.

Although the present disclosure will be described with reference to the specific embodiments shown in the accompanying drawings, it should be understood that the fastening nut of the present disclosure can have many variations without departing from the spirit, scope and background of the teachings of the present disclosure. Those of ordinary skill in the art will also appreciate that there are different ways to alter the structure in the embodiments disclosed in the present disclosure, and all the alterations fall within the spirit and scope of the present disclosure and claims.

1. A fastening nut, comprising:
a collar; and
a receiving column, wherein the receiving column is connected to one side of the collar, and the receiving column comprises:
an engageable receiving portion, inwardly-protruding engaging teeth being provided on at least part of an inner wall of the engageable receiving portion; and
a deformable receiving portion, the deformable receiving portion connecting the engageable receiving portion to the collar, the deformable receiving portion comprising an upper barrel and a lower barrel connected to each other, wherein the upper barrel is connected to the collar, the lower barrel is connected to the engageable receiving portion, the upper barrel has a right cone shape, the lower barrel has an inverted cone shape, and an outwardly-protruding bent portion is formed at a joint between the upper barrel and the lower barrel; and the deformable receiving portion comprises at least two holes provided at intervals in a circumferential direction of the receiving column, each of the at least two holes extending from the upper barrel to the lower barrel.

2. The fastening nut according to claim 1, wherein the deformable receiving portion comprises at least two legs formed between adjacent holes, each of the at least two legs comprising an upper leg and a lower leg,
wherein the upper leg is formed by the upper barrel, the lower leg is formed by the lower barrel, and the upper leg and the lower leg are connected at the bent portion; and
wherein the upper leg extends from the bent portion to the collar in an inwardly inclined manner, and the lower leg extends from the bent portion to the engageable receiving portion in an inwardly inclined manner.

3. The fastening nut according to claim 2, wherein an included angle formed between the upper leg and the lower leg is an obtuse angle.

4. The fastening nut according to claim 1, wherein the engageable receiving portion comprises an engageable receiving cylinder and a guide portion, the guide portion connecting the engageable receiving cylinder to the deformable receiving portion, and a minimum inner diameter of the deformable receiving portion is greater than a maximum inner diameter of the engageable receiving cylinder.

5. The fastening nut according to claim 4, wherein the guide portion forms a spherical surface.

6. The fastening nut according to claim 2, wherein the at least two legs are symmetrically arranged with respect to a center of the receiving column.

7. The fastening nut according to claim 1, further comprising:
an rotation preventing arm, wherein the rotation preventing arm is formed by extending downwardly from an periphery of the collar.

8. A fastening assembly, comprising:
a fastening bolt, the fastening bolt having a thread; and
a fastening nut according to claim 1,
wherein the thread of the fastening bolt is engageable with the inwardly-protruding engaging teeth of the engageable receiving portion of the fastening nut, and the fastening nut is configured in such a way that when the fastening bolt is inserted into the receiving column of the fastening nut and engages with the engageable receiving portion of the receiving column, the deformable receiving portion of the fastening nut is bent and deformed such that the engageable receiving portion moves toward the collar.

9. The fastening assembly according to claim 8, wherein the fastening assembly is used for being mounted in a mounting hole of a mounting panel,
wherein the size of the mounting hole of the mounting panel is greater than the minimum size of the deformable receiving portion and less than the maximum size of the deformable receiving portion.

10. The fastening assembly according to claim 9, wherein the fastening nut comprises an rotation preventing arm, the rotation preventing arm being formed by extending downwardly from an periphery of the collar, and the rotation preventing arm being configured to be inserted into an rotation preventing hole in the mounting panel.
